(19) United States
(12) Patent Application Publication
(10) Pub. No.: US 2008/0199110 A1
(43) Pub. Date: Aug. 21, 2008

(54) Fluids container

(76) Inventors: Brent Anderson, Barrington, IL (US); Howard W. Schwan, Crystal Lake, IL (US)

Correspondence Address: Everest Intellectual Property Law Group, P.O. Box 708, Northbrook, IL, 60065, US

(21) Appl. No.: 11/207,563

(22) Filed: Aug. 19, 2005

Related U.S. Application Data
(63) Continuation-in-part of application No. 10/042,955, filed on Jan. 8, 2002, now Pat. No. 6,984,278.

(51) Int. Cl. B65D 30/10; B65D 30/02; B29C 63/48

(52) U.S. Cl. 383/109; 383/105; 156/209

(57) ABSTRACT

The present invention provides a method for treating a surface of a layered polymeric structure. The method includes the steps of: (1) providing a film having a layered structure formed by adhering first and second non-molten polymeric sheets in an overlap and texturing a surface of the first or second non-molten sheets with a chill roll to form fluid pathways on a surface of the film; (2) attaching an access member to the film; and (3) forming the film into a container having a peripheral seal defining a chamber, and having the fluid pathways facing the chamber and having the fitment providing access to the chamber.

### CROSS-REFERENCE TO RELATED APPLICATION

This is a continuation-in-part of U.S. patent application Ser. No. 10/042,955 which was filed on Jul. 8, 2002, and which is incorporated herein by reference and made a part hereof.

### TECHNICAL FIELD

The present invention relates generally to a method for texturing a film and more particularly for texturing a film to be fabricated into a fluid container.

### BACKGROUND OF THE INVENTION

Collapsible plastic bags are often used to store liquid products such as chemicals, soft drink syrup, fruit juices and food condiments. The plastic bags are typically housed in a corrugated paperboard box to aid in the transporting, handling and dispensing of the product. Such packaging systems are commonly referred to as “bag-in-box” packaging systems.

The plastic bags typically have sidewalls sealed along a peripheral seam to define a fluid containing chamber. A spout or a fitment provides access to the fluid chamber for filling and dispensing the product within the bag. Vacuum pump systems are sometimes connected to the container to assist in draining fluid from the container. Both gravity dispensing bags and vacuum pump systems suffer from the common drawback that fluid may become trapped within the folds of the bag during draining. Because of this, evacuation channels are often placed within the bag. Evacuation channels are typically elongate cylindrical tubes or flat strips with protruding ribs defining grooves. Typically, one end of the evacuation channel is disposed transverse to, or is connected to the spout, and the other end of the evacuation channel extends into the fluid containing chamber of the bag. As the bag is emptied by the force of the vacuum pump, or by the force of gravity, portions of the bag collapse unevenly, tending to leave pockets of product, typically liquid, which may become isolated from the rest of the liquid in the container. The evacuation channel, however, forms a conduit which cannot be closed off by the folds created in the bag. In this manner the entire chamber of the flexible bag remains in communication with the spout at all times during the dispensing such that all product within the bag can be removed.

Prior attempts to provide such bags are disclosed in U.S. Pat. Nos. 4,601,410; 5,647,511 and 5,749,493. U.S. Pat. Nos. 4,601,410 and 5,647,511 disclose a liquid container with an evacuation unit. In both the '410 and '511 patents, the evacuation unit is shown attached directly to the spout by a mounting ring. Several problems have been encountered with these types of evacuation units. For example, during the filling process, which is typically done in a high speed and high pressure process, the evacuation unit is susceptible of being dislodged from the spout thereby rendering the evacuation unit inoperative. Also, the attaching ring can impede the flow of liquid during the filling process thereby slowing the filling process.

U.S. Pat. No. 5,749,493 discloses an evacuation unit positioned within a bag and transverse and perpendicular to a spout in the bag. Because the evacuation unit is positioned in a location that is in line with the incoming fluid during the filling process, it is susceptible of being dislodged from its mounting to the container thereby rendering it ineffective. The '493 Patent also discloses extruding a pair of ribs or a single rib or protuberance extending the length of the container.

Many of the designs which utilize an evacuation unit positioned within the bag require that the unit be placed into the bag after the bag has been substantially constructed. This is undesirable because it adds another step to the manufacturing process and increases the labor costs.

U.S. Pat. No. Re. 34,929 discloses a plastic bag having interconnected air channels on its inner surface for the vacuum packaging of perishable items. The air channels are formed by the spaces between a plurality of raised protuberances having uniform thickness and formed in a generally regular and waffle-like pattern. The protuberances prevent the total collapse of the bag during air evacuation. There is no disclosure to utilize a fitment to provide access to the contents of the container. There is also no disclosure of removing the stored contents of the bag, but, rather only discloses moving air from the package to prevent spoilage of the perishable item contained therein.

U.S. Pat. Nos. 2,778,171 and 2,778,173 each disclose producing air-tight packages for packaging perishable items such as food. Projections are provided near an opening of the air-tight package for keeping sidewalls of the container from fully collapsing against one another while air is being evacuated from the container. There is no disclosure of evacuating a stored product from the container and no disclosure of providing a fitment with the bag to provide access to the stored contents.

U.S. Pat. No. 5,728,086 discloses a flexible container having multiple access ports and particularly discloses a container for storing fluids for parenteral administration to a patient. An inner surface of a sidewall of the container can have various patterns embossed thereon to assist in draining the contents of the container.

U.S. Pat. No. 5,928,762 discloses a laminate of a base film and an embossed sheet and a method for fabricating the same. The method includes the steps of joining a base sheet to a molten sheet material. The molten sheet material is cooled and solidified using a cooling roll having embossing patterns in its surface. The method includes the steps of embossing the molten sheet and simultaneously laminating the molten sheet with the base sheet. In an alternative method, an adhesive resin is coextruded on the side of the molten sheet facing the base material. There is no disclosure in the '762 Patent of utilizing more than a single preformed sheet material to fabricate a layered polymeric structure.

### SUMMARY OF THE INVENTION

The present invention provides a method for forming a container or a pouch. The method includes the steps of: (1) providing a film having a layered structure formed by adhering first and second non-molten polymeric sheets in an overlap and texturing a surface of the first or second non-molten sheets with a chill roll to form fluid pathways on a surface of the film; (2) attaching an access member to the film; and (3) forming the film into a container having a peripheral seal defining a chamber, and having the fluid pathways facing the chamber and having the fitment providing access to the chamber.

### BRIEF DESCRIPTION OF THE DRAWINGS

FIG. 1 is a perspective view of a container having a fitment;

FIG. 2a is a side view of walls of a container having a fluid contacting inner surface having a texture defining a pattern that is self interlocking;

FIGS. 2b-e show a top plan view of various patterns having protuberance distributions including, respectively, aligned, staggered, a combination of aligned and staggered and random;

FIG. 3 is a plan view of a textured surface having a plurality of spaced protuberances having a variety of shapes;

FIG. 4 is a sidewall of the container of FIG. 1 having a plurality of regularly spaced rectangular protuberances to define a checkerboard or waffle pattern;

FIG. 5 is a sidewall having circular protuberances together forming a circular pattern with a series of X-shaped protuberances forming S-shaped lines;

FIG. 6 is a top plan view of a brick wall pattern;

FIG. 7 is a schematic view of a process for texturing a surface of a film;

FIG. 8 is a cross-sectional view of a multiple layered film having a textured surface;

FIG. 9 is a pouch having a textured inner surface; and

FIG. 10 is a schematic of a system for forming a pattern on a sidewall of a pouch or a container in-line with the container or pouch forming machinery.

### DETAILED DESCRIPTION

While this invention is susceptible of embodiment in many different forms, herein will be described in detail with the accompanying figures, a preferred embodiment of the invention. The present disclosure is to be considered as an exemplification of the principles of the invention and is not intended to limit the broad aspect of the invention to the embodiments illustrated and described.

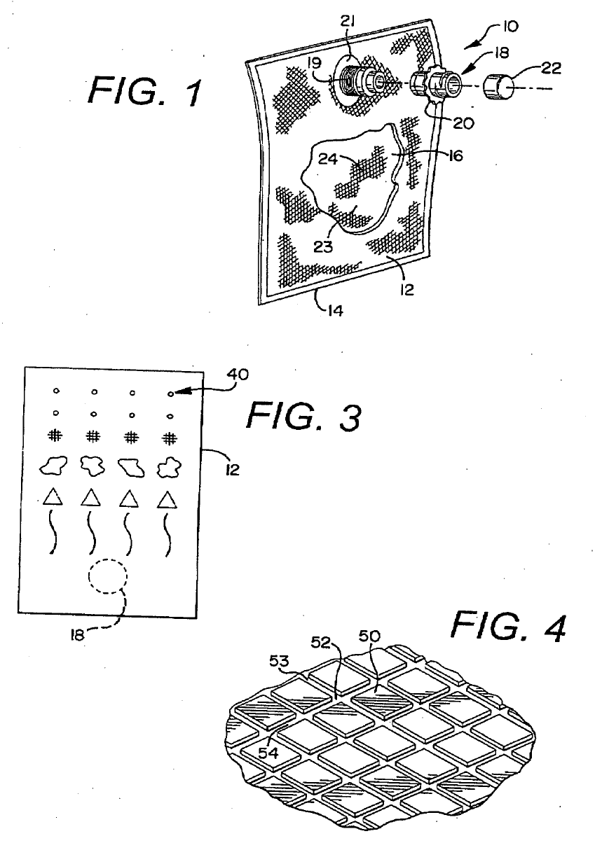

FIG. 1 shows a flexible container assembly 10 having a first sidewall 12 and a second sidewall 13 attached at peripheral edges 14 to define a fluid tight chamber 16. The first sidewall 12 has a through-hole and a fitment 18 secured at the hole. The fitment 18 has three pieces: a spout member 19 having a flange 21, a valve member 20 having a check valve therein and a cap 22. The fitment provides fluid flow access to the chamber 16. An inner, product contacting surface 23 of one or both sidewalls are shown having a textured pattern extending inwardly or outwardly from the surface 23, to define fluid pathways. In a preferred form of the invention, the first and second sidewalls 12 and 13 are a flexible polymeric material having a modulus of elasticity of less than 50,000 psi. In a preferred form of the invention the sidewalls have sufficient flexibility to collapse upon draining.

The sidewalls can be formed from a monolayer film, a multiple layer film or can be formed of several individual sheets or plys of such films joined together at their peripheries to define a multiple sheet sidewall.

Suitable polymeric materials for forming these films include polyolefins, ethylene and vinyl acetate copolymers, ethylene copolymerized with carboxylic acids having from 3 to 20 carbons and ester and anhydride derivatives thereof, ethylene and vinyl alcohol copolymers, polyamides, polyesters, polyvinyl chloride, PVDC and the like. The film can be formed by polymer processing techniques well known in the art including, but not limited to, extrusion, coextrusion, molding, blow molding, blown extrusion, lamination and the like. The films can also be treated by primers, ozonolysis, and can be metalized.

Suitable polyolefins include homopolymers such as polyethylene, polypropylene, polybutene, etc., and copolymers of ethylene and α-olefins where the α-olefins have from 3-20 carbons, and more preferably from 4 to 8 carbons. Suitable polyethylene homopolymers include those commonly referred to as low density polyethylene (LDPE). Suitable ethylene and α-olefin copolymers include, for example, ethylene butene copolymers, ethylene hexene copolymers and ethylene and octene copolymers. These copolymers are commonly referred to as linear low density polyethylene (LLDPE), very low density polyethylene (VLDPE) and ultra-low density polyethylene (ULDPE) and typically have a density of less than about 0.915 g/cc.

Suitable polyamides include polyamides formed from condensation reactions of diamines and dicarboxylic acids or ring opening reactions of caprolactams. In a preferred form of the invention the polyamides are selected from the group nylon 6,6, nylon 6, and nylon 6,12 and even more preferably is nylon 6.

The container 10 can be made from individual sheets of film placed in registration and sealed along the periphery 14 using standard sealing techniques well known in the art.

FIG. 1 shows the fitment 18 extends from the first sidewall 14 and having an axis essentially perpendicular to a planar surface of the first sidewall 12 of the container. It is contemplated the fitment 18 can be mounted at various angles to the sidewall without departing from the present invention. Typically, container 10 is used for housing liquids, such as soft drink syrups, which are withdrawn from the container under pressure with a hose and mixed at a fountain type dispenser with a diluent such as carbonated soda water. The hose (not shown) has an attachment for connecting to the fitment in a fluid and air tight arrangement. A vacuum pressure is applied to the fitment 18 through the hose to withdraw fluid under pressure from the container. Of course, the fitment 18 may be attached to the first or second sidewall 12, 13 or both and may be located at any location thereon.

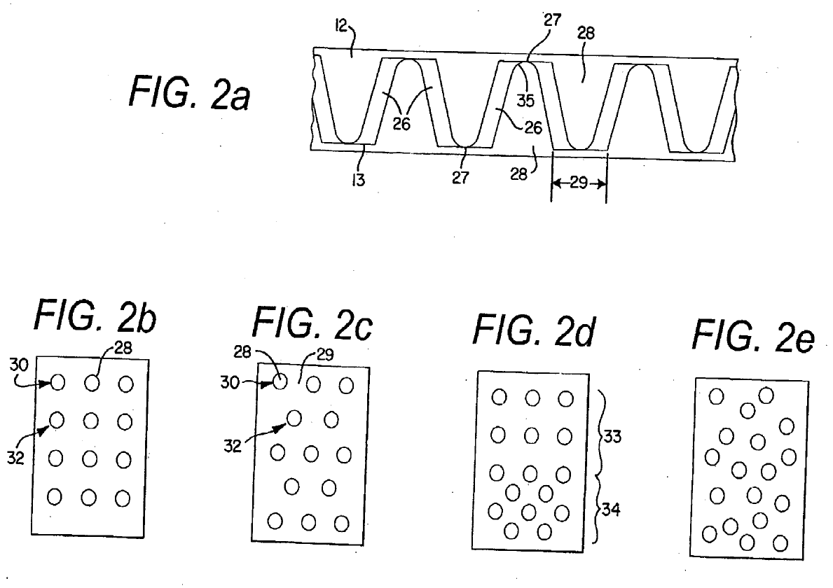

FIG. 2a shows a layer structure 25 formed from the first sidewall 12 and the second sidewall 13 in surface contact with one another. Fluid pathways 26 exists and are maintained through the layer structure even when the sidewalls are in contact with one another under the force of gravity or when being forced together during fluid evacuation from the container under vacuum pressure at pressures typically encountered in the normal use of such container. Each of the first sidewall and the second sidewall has a substrate 27 from which a plurality of objects 28 extend outwardly or inwardly from the substrate. The objects 28 are separated by gaps 29. In a preferred form of the invention, the objects of one substrate can be brought into registration with and intercalate into the gaps 29 of another substrate to interlock the substrates together. What is meant by the term “interlock” is that the layer structure resists lateral movement of one substrate with respect to the other substrate. This is in contrast to an axial interlock where the substrates resist movement away from one another in a direction along an axis of the object. The term “interlock” includes separably interlocked or permanently interolocked. What is meant by separably interlocked is that one substrate of the layer structure can be disengaged from another substrate of the layer structure without destroying or damaging the substrates. What is meant by permanently interlocked is that the one substrate of the layer structure cannot be disengaged from the other substrate without damaging or destroying the layer structure. The modifier “separably” and “permanently” will also be used with respect to the term “axial interlock.” Regardless of whether the substrates are separably or permanently interlocked, fluid pathways 26 will be maintained through the layer structure.

FIG. 2a shows a pattern where the objects are generally circular-dome shaped. The protuberances can be spaced from one another such as in aligned rows (2b), staggered rows (2c), a combination of aligned rows 33 and staggered rows 34 (2d) or randomly (2e). Aligned rows (FIG. 2b) means that each object in one row 30 is in alignment with an object in an adjacent row 32. Staggered rows (FIG. 2c) mean that an object 28 in one row 30 is in alignment with a gap 29 in an adjacent row 32. FIG. 2d shows a combination of both aligned rows 33 and staggered rows 34 across a web of film.

The layer structure shown in FIG. 2a has a distal end of each object 35 contacting the substrate 27 in the gap 29 so as to act like columns to provide support to the structure along the object. Thus, even when the layer structure is under compressive forces, like, for example, when fluid is being evacuated from a container under vacuum pressure, the fluid pathways in the layer structure will be maintained in an open position. It is contemplated the objects can have a shape at a distal end that is complementary to a shape of the gap, formed by the shape of the proximal portions of the surrounding objects to form a lock and key arrangement to securely hold the objects in the gap to interlock and axially interlock the substrates together. It should be understood that different portions of a single sidewall can interlock or that portions of the first sidewall can interlock with portions of the second sidewall.

FIG. 3 shows a plurality of objects 40 on the sidewall 12. In a preferred form of the invention the objects 40 are positioned on a fluid contacting surface of the sidewall. The objects 40 can be positioned on a single sidewall or both. The objects, in a preferred form of the invention, are provided over substantially an entire surface of the sidewall but could also be provided only in select areas of the sidewall without departing from the scope of the invention. The objects can be of any shape including regular shapes such as circular, polygonal, straight or curved lines, symbols or the like. The objects can also be irregular or amorphous in form. These objects 40 when positioned in a fluid contacting portion of the sidewall assist in draining fluid from the chamber 16. The objects 40 can be raised protuberances or indentations in these shapes. The objects 40 can be all of the same shape or can be of any combination of varying shaped objects. In one form of the invention, the objects 40 can be positioned to extend longitudinally, lattitudinally, diagonally of the sidewall or a combination of the same. The objects 40 can be of varying sizes provided the objects are effective to provide fluid pathways through the container when the fluid or particulate contents of the container is being evacuated.

The objects 40 can form a regular pattern or an irregular pattern. The regular pattern includes objects being placed at the same or essentially the same spacing or a repeating sequence of spacings. The irregular pattern is one where the objects are generally randomly distributed.

In another preferred form of the invention as shown in FIG. 4, a regularly spaced pattern of rectangular-shaped objects 50 having pathways 52 defined therebetween. This checkerboard or waffle pattern has at least a first pathway 53 intersecting a second pathway 54. In a preferred form of the invention, the pathways intersect substantially perpendicular to one another. However, it is contemplated the intersection of pathways 52 can form various angles without departing from the present invention.

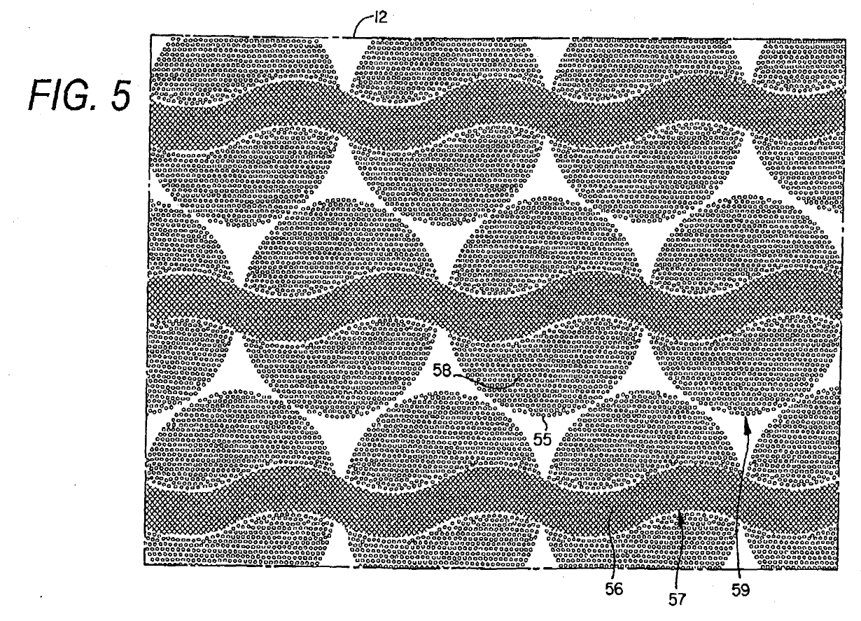

FIG. 5 shows another preferred form of the invention having a plurality of circular protuberances 55 grouped together with X-shaped protuberances 56 on a sidewall. The circular protuberances 55 are grouped to define a circular shape 58 pattern. The X-shaped protuberances 56 are grouped to define an S-shaped pattern 57. The x-shaped pattern 57 is positioned within the circular shaped pattern 58 to define a sum object 59. The sum object 59 is shown to be a company logo but could also be other indicia such as a trademark, a tradename, instructions for use of the film or object made from the film or other identifying or useful information or advertising that can be viewed through one of the sidewalls 12 or 13 or both.

A plurality of sum objects 59 are shown connected together to define a web of interconnected sum objects. It is contemplated that the sum objects 59 could be positioned in other relationships and other patterns without departing from the scope of the invention. Of course it is also contemplated that any combination of shapes of protuberances can be used and that more than two different shapes can be used together to form patterns of various shapes and sizes.

FIG. 6 shows yet another pattern resembling a brick wall 60. The pattern is defined by a plurality of stacked rows 62 of a plurality of adjacent rectangular objects 64 separated by fluid pathways 65. A fluid pathway 66 extending between lateral edges 67 of a pair of adjacent rectangular objects in one row 68 is in alignment with a central edge portion 70 of a rectangular object in an adjacent row 72. This pattern is repeated to define what resembles a brick wall.

The present invention further provides a process for evacuating the container shown in FIG. 1. The method for evacuating a fluid from a container comprises the steps of: (1) providing a liquid filled container having a sidewall having an inner surface; (2) providing a plurality of objects on the inner surface of the sidewall to define a plurality of channels having at least a first channel and a second channel intersecting one another; (3) providing a fitment attached to the sidewall, the fitment having an opening therethrough having an axis substantially perpendicular to the outer surface; and (4) applying a suction to the fitment to draw fluid from the container.

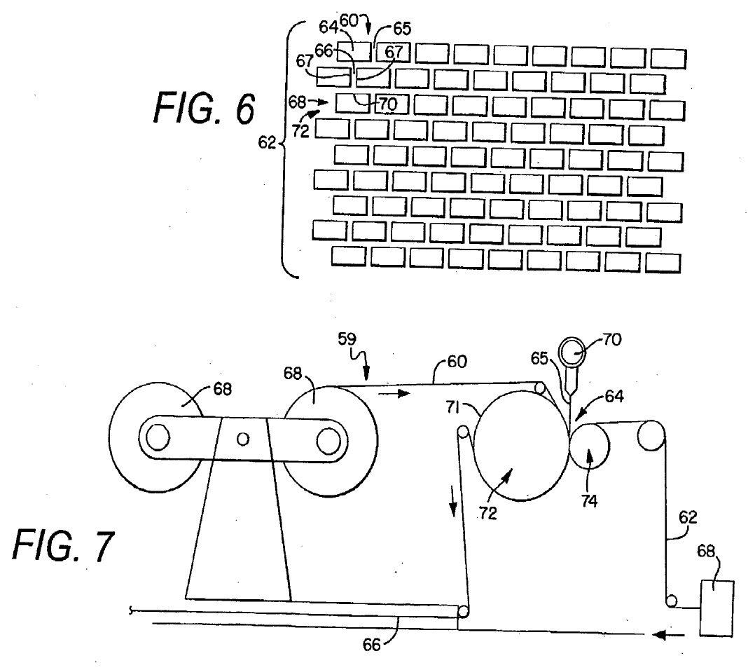

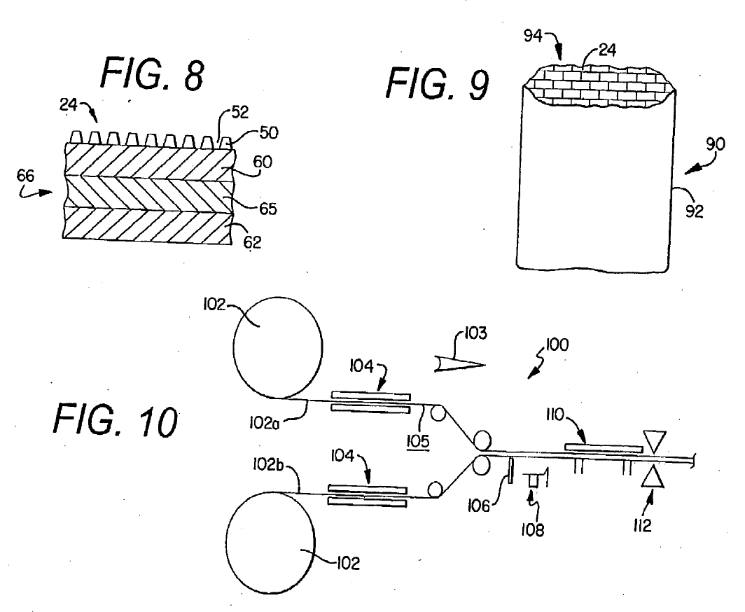

FIG. 7 shows a texturing station 59 where a preferred method for imparting the pattern on the films. The method comprises the steps of: (1) providing a first sheet of material 60, (2) providing a second sheet of material 62, (3) positioning the first sheet 60 or the second sheet 62 to overlap at least a portion of the other sheet to define an interference zone 64, (4) directing a first polymeric material 65 into the interference zone 64 to adhere the first sheet 60 to the second sheet 62 to form a layered structure 66 (FIG. 8), and (5) texturing a surface of the first sheet or the second sheet to form a pattern on the surface.

In a preferred form of the invention, the first sheet and the second sheet are polymeric films as described above. However, it is contemplated that the first sheet and/or the second sheet could be selected from paper or metal foil provided that one of the layers is capable of maintaining the pattern during regular use of the layered structure 66.

The first sheet 60 can be a monolayer structure or a multiple layered structure as set forth above. The monolayer structure can be of a polymer blend of the polymeric components. The multiple layered structure can have a layer or more than one layer of a polymer blend of the polymeric components. In one preferred form of the invention the first sheet is a film having a layer of a polyolefin and more preferably an ethylene and α-olefin copolymer, and even more preferably is an LLDPE. Such a first sheet having an LLDPE layer has been found to be well suited to form a seal layer or liquid contacting layer of a container 10 as LLDPE forms strong, durable seals.

In another preferred form of the invention, the first sheet 60 can also be a multiple layered polymeric structure having a first layer of a polyolefin and a second layer to provide additional attributes to the film such as scratch resistance, barrier to the transmission of gasses or water vapor or the like. Suitable materials to form a barrier material include ethylene and vinyl alcohol copolymers, polyamides, polyesters, PVDC and metal foil to name a few. One preferred multiple layered film to form the first sheet 60 has a first layer of LLDPE and a second layer of ethylene vinyl alcohol copolymer.

The second sheet 62 is also preferably a monolayer polymeric film or a multiple layered polymeric film selected from the films and polymeric materials detailed above. In one preferred form of the invention, the second sheet 62 is a barrier material and more preferably a polyamide or polyester and even more preferably nylon 6. The first sheet 60 and the second sheet 62 can be preformed and provided on spooled rolls 68 or the sheets can be laminated or otherwise produced in line.

The step of positioning the first sheet 60 in an overlapping relationship with the second sheet 62 is accomplished using standard polymeric sheet handling machinery. In a preferred form of the invention either the first sheet 60 is positioned with respect to the second sheet 62, or the second sheet 62 is positioned with respect to the first sheet 60 or both sheets are positioned with respect to one another so that in all instances the peripheries of the first and second sheet are essentially in complete registration.

The step of directing the first polymeric material 65 into the interference zone 64 to adhere the first sheet 60 to the second sheet 62 to form the layered structure 66 can be carried out by flowing polymeric material in a molten form into the interference zone 64. Molten polymeric material can be provided under pressure to the interference zone 64 using an extrusion die 70. The polymeric material may be extruded as a single polymeric material or a blend of polymeric materials. The polymeric material may also have multiple layers coextruded from a coextrusion die. It is also contemplated to that the first polymeric material can be an adhesive that can be sprayed or otherwise spread or distributed into the interference zone 64. In a preferred form of the invention the first polymeric material is a polyolefin and more preferably an ethylene homopolymer and even more preferably a LDPE.

The step of texturing the film can include the step of imparting a desired pattern described above onto the first sheet 60 or the second sheet 62 or both. The pattern is typically only on one surface as shown in FIG. 8 of the sheet but could be made to extend through the entire thickness of the film and be evident on opposed surfaces. The step can be carried out prior to the step of joining the sheets together, substantially or essentially simultaneously with the step of adhering the first and second sheets together, as shown in FIG. 7, or after the step of adhering the first sheet to the second sheet. In a preferred form of the invention the step of texturing is carried out substantially simultaneously with the joining step.

The step of texturing the film includes the step of bringing the sheet or layered structure to be textured into cooperative engagement with a surface having the desired pattern thereon. In a preferred form of the invention, the surface 71 is located on a roll and more preferably a chill roll 72. The chill roll 72 can be fabricated from any suitable material such as metal, plastic or cork. The chill roll 72 can have the pattern extending inward of its outer surface or can extend outward from its outer surface. The sheet or structure is held in cooperative engagement against the chill roll 72 using a back-up roll 74. The back-up roll 74 can be made from metal, rubber, plastic or paper and most preferably rubber. It should be understood that either the chill roll 72, the back-up roll 74 or both can carry the pattern.

After the layered structure 66 passes the chill roll it proceeds along to a spooling station or to be fabricated into useful objects like the container 10 or pouch 90.

FIG. 8 shows the layered structure 66 having the first sheet 60 joined to the second sheet 62 by polymeric material 65. Objects 20 are shown on the first sheet 60 but could be positioned on sheet 62 or both sheets 60 and 62 without departing from the present invention.

FIG. 9 shows a pouch 90 having a peripheral seal 92 along three peripheral edges and an open end 94. The pouch 90 has opposed sidewalls 96 each having an interior, product contacting surfaces. Each of the surfaces have a series of objects in one of the shapes described herein to form fluid evacuation channels. In a preferred from of the invention, the pattern is the brick-wall pattern shown in FIG. 6.

In a preferred form of the invention, the pouch 90 will be used as a food storage container after having been filled with a food or other item to be stored and sealed along its open end 94 with a sealing device. Certain sealing devices present in the market will also remove excess air from the container and seal the container to form a long-term storage food container. Suitable sealing devices include FOODSAVER®, RIVAL® SEAL-A-MEAL®, BLACK & DECKER® FRESHGUARD®, DENI® MAGIC VAC®, and KENMORE® vacuum sealer system.

In a preferred form of the invention, the pouch will be fabricated from a three-layer film having an outer layer an intermediate layer and an interior, material contacting layer. The outer layer is preferably a polyamide, more preferably a nylon, even more preferably nylon 6. In a preferred form of the invention the polyamide is mono- mono-axially and more preferably biaxially oriented. The intermediate layer is preferably a polyolefin, more preferably a polyethylene and most preferably a polyethylene having a density of less than 0.915 g/cc. The inner layer is preferably a polyolefin, more preferably a polyethylene and most preferably a polyethylene having a density of less than 0.915 g/cc. Also, in a preferred form of the invention, the pattern is applied to the film using the chill roll or the back-up roll 74 and more preferably the back-up roll 74.

FIG. 10 shows an alternative system 100 and apparatus for forming the patterns described herein on a surface of a film to form an inner surface of a pouch or a container. In one preferred form of the invention, two rolls of rolled film stock 102 are provided and are used to form opposed side walls of the pouch or the container. While this invention is described having a separate roll stock for each sidewall it is contemplated utilizing a single roll stock that is folded to form opposed sidewalls of the pouch or container. The film is pulled in indexed cycles from the roll stock in the direction of arrow 103 using standard equipment through a series of processing stations to form a sealed container or a pouch having an open end. In the first station 104, a heated surface such as on a die, roll, stamp or plate with one of the patterns disclosed herein is brought into cooperative engagement with a planar surface of the film stock to form a pattern on one or both planar surfaces of the film. Preferably, the pattern is only formed on one surface of the film 105 that will define an inner surface of the pouch or container being formed. While FIG. 10 shows a pattern being imparted on both films 102a and 102b, it is contemplated that the pattern could be formed on only one of the films 102a or 102b.

After the pattern has been formed on the film or films, the film is drawn through an optional hole punch station 106 where a hole is cut from a sidewall to accommodate an access member. Of course, in the case of a pouch that is used for vacuum sealing, there typically is no need for the hole punch station as no access member is attached to a sidewall of the pouch.

After the hole is removed from the sidewall an access member is sealed to the sidewall and extends through the hole at station 108. Typically the access member will have a flange or other item that is heat sealed to an inner or outer surface of the sidewall, and for bag-in-box type applications, preferably a flange 21 of an access member 18 is heat sealed to an inner surface of the sidewall and a spout portion of the access member extends through the through-hole as shown in FIG. 1.

Next, the films 102a,b are indexed into sealing station 110. Here the film layers are heat sealed to form a pouch or a container. The heat sealing can be carried out using conductive or inductive heat sealing techniques. The heat sealing can include using a die that forms the peripheral edges of one or more containers or pouches simultaneously.

Next the container or containers form are indexed to station 112 where the containers are cut from the line of containers or pouches being formed. The finished containers or pouches are then packaged for shipment.

While the specific embodiments have been described, numerous modifications come to mind without significantly departing from the spirit of the invention and the scope of protection is only limited by the scope of the accompanying claims. This design is just one example of a pattern design having these favorable characteristics, and disclosure of it is merely one example of a design having its favorable characteristics, others of which are not significant departures from the spirit of the invention.

We claim:

1. A method for forming a container comprising:
providing a film having a layered structure formed by adhering first and second non-molten polymeric sheets in an overlap and texturing a surface of the first or second non-molten sheets with a chill roll to form fluid pathways on a surface of the film;
attaching an access member to the film; and
forming the film into a container having a peripheral seal defining a chamber, and having the fluid pathways facing the chamber and having the fitment providing access to the chamber.

2. The method of claim 1 wherein the first and second non-molten sheets are joined together by directing a molten polymeric material into the overlap.

3. The method of claim 1 wherein the container has opposed sidewalls each sidewall having fluid pathways facing the chamber.

4. A fluid container comprising:
a wall defining a chamber, the wall having a layered structure formed by adhering first and second non-molten polymeric sheets in an overlap and texturing a portion of the surface of the first or second non-molten sheets with a chill roll to form fluid pathways on a portion of the surface of the film facing the chamber; and
an access member fixedly attached to the wall for providing access to the chamber.

5. The container of claim 4 wherein the wall has opposed portions defining opposed sidewalls, each sidewall having an inner surface facing the chamber and at least a portion of one of the opposed sidewalls having the fluid pathways.

6. The container of claim 5 wherein portions of each opposing sidewall inner surfaces having fluid pathways.

7. The container of claim 4 wherein the fluid pathways define a waffle pattern.

8. The container of claim 4 wherein the fluid pathways define a brick-wall pattern.

9. The container of claim 4 wherein the fluid pathways are defined by a plurality of spaced objects.

10. The container of claim 9 wherein the objects have a generally circular shape.

11. The container of claim 9 wherein the objects have a polygonal shape.

12. The container of claim 9 wherein the objects have an irregular shape.

13. The container of claim 9 wherein the objects have a generally teardrop shape.

14. The container of claim 9 wherein the objects have a first set of objects with a first shape and a second set of objects with a second shape different from the first shape.

15. The container of claim 9 wherein the objects are dimension to fit within gaps separating the objects to define a self-interlocking pattern.

16. The container of claim 4 wherein the first non-molten sheet is a monolayer structure or a multiple layered structure.

17. The container of claim 4 wherein the first non-molten sheet is a monolayer structure.

18. The container of claim 4 wherein the first non-molten sheet is a multiple layered structure.

19. The container of claim 18 wherein the multiple layered structure has a first layer and a second layer.

20. The container of claim 19 wherein the first layer is a polyolefin.

21. The container of claim 20 wherein the second layer is a barrier material.

22. The container of claim 4 wherein the second non-molten sheet contains a layer of a polyamide or a layer of a polyester.

23. A fluid container comprising:
a wall defining a fluid tight chamber and having an inner surface facing the chamber;
an access member attached to the wall and providing fluid access to the chamber;
a pattern on the inner surface defining a fluid pathway to the access member, the pattern having an object spaced from a gap and the object being dimensioned to fit into the gap to interlock the object and the gap.
